(19) United States
(12) Patent Application Publication
(10) Pub. No.: US 2024/0268381 A1
(43) Pub. Date: Aug. 15, 2024

(54) Agricultural Chemical Formulation

(71) Applicants: Nan HU, Houston, TX (US); Maria MILINA, Glen Ridge, NJ (US); Chunzhao LI, Webster, TX (US); Virginia VANCE, Seabrook, TX (US); Anna TANCORRA, Overijse (BE); Aaron Eberle, Spring, TX (US); ExxonMobil Chemical Patents Inc., Baytown, TX (US)

(72) Inventors: Nan Hu, Houston, TX (US); Maria Milina, Glen Ridge, NJ (US); Chunzhao Li, Webster, TX (US); Virginia Vance, Seabrook, TX (US); Anna Tancorra, Overijse (BE); Aaron Eberle, Spring, TX (US)

(21) Appl. No.: 18/561,642

(22) PCT Filed: May 17, 2022
(86) PCT No.: PCT/EP2022/063296

§ 371 Date: Nov. 16, 2023

Related U.S. Application Data
(60) Provisional application No. 63/194,422, filed on May 28, 2021.

(30) Foreign Application Priority Data
Aug. 27, 2021 (EP) 21193490.6

(51) Int. Cl. A01N 31/04; A01N 25/02; A01P 13/02

(52) U.S. Cl. CPC A01N 31/04; A01N 25/02; A01P 13/02

(57) ABSTRACT

Provided herein is an agrochemical composition suitable for use as an emulsifiable concentrate, comprising one or more active ingredients; one or more solvents selected from specific amides and esters; and optionally, one or more surfactants.

### FIELD OF THE INVENTION

The present disclosure relates to agricultural chemical compositions, uses thereof, and methods for protecting crops.

### BACKGROUND OF THE INVENTION

Agrochemical compositions are often provided as mixtures or blends of one or more active ingredients such as insecticides, herbicides, fungicides, and nematicides, solvent, and one or more other components such as surfactants, promoters, and adjuvants. Often, such chemicals are distributed in liquid emulsifiable concentrates which can be blended with water at the treatment site to produce an emulsion that is distributed over crops and/or pests, typically by spraying.

It is desirable that the solvent used in such concentrate has a high solvency for the one or more active ingredients, a low solubility in water, and low toxicity. There remains a need for solvents providing a good balance of solvency, water solubility, and toxicity.

### SUMMARY OF THE INVENTION

It is an object of the present application to provide agrochemical compositions comprising one or more active ingredients, one or more solvents, and optionally one or more surfactants. The agrochemical compositions described herein may be used as an emulsifiable concentrate, which may be blended with water to form an emulsion.

In particular, provided herein is an agrochemical composition comprising:
one or more active ingredients, more particularly one or more organic active ingredients;
one or more solvents selected from the list consisting of:
   (a) an amide of formula R¹—C(O)—NR²R³, wherein R¹ is a branched C₈-C₁₅alkyl, preferably a branched C₉-C₁₅alkyl, and R² and R³ are independently C₁-C₄alkyl;
   (b) an ester of formula R⁴—C(O)—OR⁵, wherein R⁴ is a branched C₄-C₈alkyl or isopropyl, and R⁵ is a methyl or ethyl group substituted with an aromatic substituent selected from phenyl or naphthalenyl, wherein the aromatic substituent itself is optionally substituted with up to two alkyl groups selected from methyl and ethyl;
      and
   (c) an ester of formula R⁶—C(O)—OX—R⁷, wherein R⁶ is phenyl, benzyl, or naphthalenyl, optionally substituted with up to two methyl groups, X represents a single bond or a C₁-C₄alkylene group, and R⁷ is secondary butyl, cyclohexyl, or isooctyl, wherein the cyclohexyl is optionally substituted with up to two methyl groups;
   and
   optionally, one or more surfactants.

Further provided herein is an emulsion comprising said agrochemical composition and water.

The present inventors have surprisingly found that the solvents used in these formulations allow for dissolving a wide variety of agriculturally active ingredients such as herbicides, while have a low solubility in water and a high hydrolytic stability. Therefore, these solvents can provide an improved and/or potentially less toxic solvent alternative for known emulsifiable concentrates.

The independent and dependent claims set out particular and preferred features of the invention. Features from the dependent claims may be combined with features of the independent or other dependent claims, and/or with features set out in the description above and/or hereinafter as appropriate.

The above and other characteristics, features and advantages of the present invention will become apparent from the following detailed description which illustrates, by way of example, the principles of the invention. This description is given for the sake of example only, without limiting the scope of the invention.

### DETAILED DESCRIPTION OF THE INVENTION

The present invention will be described with respect to particular embodiments.

It is to be noticed that the term “comprising”, used in the claims, should not be interpreted as being restricted to the means listed thereafter; it does not exclude other elements or steps. It is thus to be interpreted as specifying the presence of the stated features, steps or components as referred to, but does not preclude the presence or addition of one or more other features, steps or components, or groups thereof. Thus, the scope of the expression “a device comprising means A and B” should not be limited to devices consisting only of components A and B. It means that with respect to the present invention, the only relevant components of the device are A and B.

Throughout this specification, reference to “one embodiment” or “an embodiment” are made. Such references indicate that a particular feature, described in relation to the embodiment is included in at least one embodiment of the present invention. Thus, appearances of the phrases “in one embodiment” or “in an embodiment” in various places throughout this specification are not necessarily all referring to the same embodiment, though they could. Furthermore, the particular features or characteristics may be combined in any suitable manner in one or more embodiments, as would be apparent to one of ordinary skill in the art.

All numerical values within the detailed description herein are modified by “about” the indicated value, and take into account experimental error and variations that would be expected by a person having ordinary skill in the art.

The following terms are provided solely to aid in the understanding of the invention.

The term “alkyl” or “alkyl group” as used herein interchangeably refers to a saturated hydrocarbyl group consisting of carbon and hydrogen atoms. An alkyl group can be linear or branched, and does not include ring structures unless specifically mentioned otherwise.

The term “cycloalkyl” or “cycloalkyl group” as used herein interchangeably refers to a saturated hydrocarbyl group wherein the carbon atoms form one or more ring structures.

The term “aryl” or “aryl group” as used herein interchangeably refers to a hydrocarbyl group comprising an aromatic ring structure therein.

The term “alkylene” or “alkylene group” as used herein interchangeably refers to a saturated, divalent straight chain or branched hydrocarbon radical.

The prefix “Cₓ” or “C_{y}-C_{z}” before the term “alkyl”, “cycloalkyl”, “aryl”, or “alkylene” indicates in each case the total number of carbon atoms of the respective radical. For example, “C₄alkyl” refers to an alkyl having 4 carbon atoms, and “C₁-C₄alkyl” refers to an alkyl having 1 to 4 carbon atoms.

Provided herein are compositions suitable for use in agriculture, which contain one or more active ingredients such as pesticides. The one or more active ingredients are dissolved or suspended, preferably dissolved, in a solvent or mixture of solvents. The compositions described herein may be used as an emulsifiable concentrate, and may be blended with water to form an emulsion which can be distributed over crops or weeds, e.g. via spraying. Accordingly, the compositions described herein may also be referred to as “emulsifiable concentrate” or “concentrate”. A surfactant may be present in the composition to facilitate the preparation of the emulsion.

More particularly, provided herein is an agrochemical composition (also referred to herein as “the composition” or “the compositions”), comprising:
one or more active ingredients;
one or more solvents selected from the list consisting of:
   (a) an amide of formula R¹—C(O)—NR²R³, wherein R¹ is a branched C₈-C₁₅alkyl, preferably a branched C₉-C₁₅alkyl, and R² and R³ are independently C₁-C₄alkyl;
   (b) an ester of formula R⁴—C(O)—OR⁵, wherein R⁴ is a branched C₄-C₈alkyl or isopropyl, and R⁵ is a methyl or ethyl group substituted with an aromatic substituent selected from phenyl or naphthalenyl, wherein the aromatic substituent itself is optionally substituted with up to two alkyl groups selected from methyl and ethyl;
      and
   (c) an ester of formula R⁶—C(O)—OX—R⁷, wherein R⁶ is phenyl, benzyl, or naphthalenyl, optionally substituted with up to two methyl groups, X represents a single bond or a C₁-C₄alkylene group, and R⁷ is secondary butyl, cyclohexyl, or isooctyl, wherein the cyclohexyl is optionally substituted with up to two methyl groups;
and
optionally, one or more surfactants.

The compositions described herein comprise one or more solvents selected from:
(a) an amide of formula R¹—C(O)—NR²R³ (hereinafter also referred to as “solvent (a)”);
(b) an ester of formula R⁴—C(O)—OR⁵ (hereinafter also referred to as “solvent (b)”); and
(c) an ester of formula R⁶—C(O)—OX—R⁷ (hereinafter also referred to as “solvent (c)”);
wherein R¹, R², R³, R⁴, R⁵, R⁶, R⁷, and X are as defined above. The composition may comprise a single solvent selected from solvent (a), (b), or (c); or a blend of two or more of such solvents. Additionally, the composition may comprise one or more other (co-)solvents. In particular embodiments, at least 50 wt % of the solvents present in the composition are selected from solvents (a), (b), and (c), alternatively at least 75 wt %, at least 90 wt %, or at least 95 wt %. In certain embodiments, at least 99 wt % or essentially all solvent in the composition is selected from solvents (a), (b), and (c).

In particular embodiments, the composition comprises one or more amides of formula R¹—C(O)—NR²R³, wherein R¹ is a branched C₈-C₁₅alkyl, and R² and R³ are independently C₁-C₄alkyl.

The present inventors found that such amides can provide an excellent solvency for a variety of pesticides. Moreover, due to the branched R¹ group, the amides generally have a lower pour point compared to the corresponding amide having a linear R¹ group, preferably at least 10° C. lower. In particular embodiments, the amides have a pour point below −40° C. The pour point can be determined according to ASTM D5950.

The composition may comprise a single amide or a mixture of two or more amides of formula R¹—C(O)—NR²R³. For example, the composition may comprise two amides with a different R¹, R², and/or R³ group. The different alkyl groups may comprise isomers having the same number of carbon atoms, and/or may comprise alkyl groups having a different number of carbon atoms.

In certain embodiments, R¹ is a branched C₉-C₁₀alkyl, or a branched C₉-C₁₂alkyl. In specific embodiments, R¹ is a branched C₉-C₁₀alkyl, or a branched C₉alkyl.

In particular embodiments, R² and R³ are independently methyl or ethyl. In specific embodiments, R² and R³ are methyl.

In certain embodiments, R¹ is a branched C₉-C₁₂alkyl, and R² and R³ are independently methyl or ethyl. In some embodiments, R¹ is a branched C₉-C₁₀alkyl, and R² and R³ are methyl or ethyl.

In some embodiments, R¹ is a branched C₉-C₁₀alkyl, and R² and R³ are methyl. In specific embodiments, the solvent is or comprises N,N-dimethylneodecanamide, i.e. an amide of formula R¹—C(O)—NR²R³, wherein R¹ is a branched C₉alkyl, and R² and R³ are methyl. In such embodiments, the N,N-dimethylneodecanamide may comprise a mixture of isomers having different branched C₉alkyl groups as R¹.

In particular embodiments, the composition comprises one or more esters of formula R⁴—C(O)—OR⁵, wherein R⁴ is a branched C₄-C₈alkyl or isopropyl, and R⁵ is a methyl or ethyl group which is substituted with an aromatic substituent selected from phenyl or naphthalenyl. The aromatic substituent itself may optionally be substituted with up to two alkyl groups selected from methyl and ethyl.

In certain embodiments, R⁴ contains at least two tertiary carbon atoms (i.e. carbon atoms which each are bound to three other carbon atoms) or at least one quaternary carbon atom (i.e. a carbon atom which is bound to four other carbon atoms). Additionally or alternatively, at least the alpha carbon of the R⁴ group (i.e. the carbon directly bound to the carbon which is part of the carbonyl group of the ester) may be a tertiary or quaternary carbon atom. In particular embodiments, the alpha carbon of the R⁴ group is a quaternary carbon atom.

In particular embodiments, R⁴ is a branched C₄-C₆alkyl, for example a branched butyl, in particular tert-butyl.

In certain embodiments, R⁵ is benzyl (C₆H₅CH₂—), 2-phenylethyl (C₆H₅—CH₂—CH₂—), 1-phenylethyl (C₆H₅—CH₂(CH₃)—), phenyl (C₆H₅—), or naphthalenylmethyl (C₁₀H₇CH₂—). In further embodiments, R⁵ is benzyl (C₆H₅CH₂—).

In particular embodiments, R⁴ is a branched C₄-C₆alkyl and R⁵ is benzyl (C₆H₅CH₂—).

In specific embodiments, the solvent is or comprises benzyl pivalate, i.e. an ester of formula R⁴—C(O)—OR⁵, wherein R⁴ is tert-butyl and R⁵ is benzyl.

In particular embodiments, the composition comprises one or more esters of formula R⁶—C(O)—OX—R⁷, wherein R⁶ is phenyl, benzyl, or naphthalenyl (1-naphthalenyl or 2-naphthalenyl), optionally substituted with up to two methyl groups, X represents a single bond or a C₁-C₄alkylene group, and R⁷ is secondary butyl, cyclohexyl, or isooctyl, wherein the cyclohexyl is optionally substituted with up to two methyl groups. Preferably, R⁷ is secondary butyl or cyclohexyl, wherein the cyclohexyl is optionally substituted with up to two methyl groups.

In embodiments wherein R⁷ is isooctyl, a mixture of various isooctyl isomers may be present.

In particular embodiments, X represents a single bond or a C₁-C₂alkylene. In certain embodiments, X is a single bond, i.e. the ester is an ester of formula R⁶—C(O)—OR⁷.

In particular embodiments, R⁶ is phenyl, benzyl, or naphthalenyl. In further embodiments, R⁶ is phenyl.

In certain embodiments, X is a single bond, R⁶ is phenyl, benzyl, or naphthalenyl, and R⁷ is secondary butyl or cyclohexyl. In specific embodiments, the one or more esters comprise or are secondary butyl benzoate (Formula I), cyclohexyl benzoate (Formula II), or a mixture thereof.

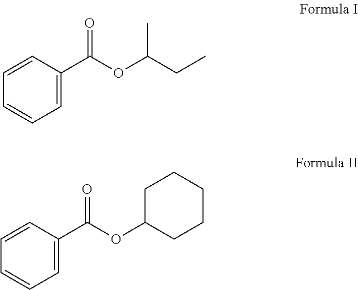

The solvent used in the compositions described herein, which may be a single solvent or a blend of different solvents, typically have a low solubility in water and a good hydrolytic stability. In particular embodiments, the solvent or solvent mixture used in the composition has a solubility in water below 0.2 wt %. The esters, i.e. solvent (b) and (c) described above, can have a particularly low solubility in water, for example below 0.05 wt %, or below 0.02 wt %. The solvent solubility in water and water solubility in solvent can be measured by the method set out in the examples.

The compositions described herein comprise one or more active ingredients useful in agriculture, also known as “agrochemicals” or “agrichemicals”. The one or more active ingredients typically include at least one pesticide or substance for pest control. Examples of pesticides include, but are not limited to, herbicides, insecticides, fungicides, acaricides, nematicides, miticides, rodenticides, bactericides, molluscicides, bird repellents, and combinations thereof.

The one or more active ingredients are typically organic compounds, i.e. chemical compounds that contain carbon-hydrogen bonds. More particularly, the one or more active ingredients preferably are organic pesticides.

In particular embodiments, the one or more active ingredients contain at least one herbicide. Non-limitative examples of suitable herbicides include dinitroaniline herbicides, synthetic auxins, nitrile herbicides, aminopyridine herbicides, triazolinone herbicides, amide herbicides, chloroacetanilide herbicides, quinolone herbicides, thiophene herbicides, pyrimidinedione herbicides, triazine herbicides, and derivatives (e.g. esters or salts) thereof. Esters derivatives may be formed if the herbicide contains a carboxyl group (the ester then being the condensation product of the herbicide and an alcohol, preferably an alcohol having 1 to 10 carbon atoms) or hydroxyl group (the ester then being the condensation product of the herbicide and a carboxylic acid, preferably a carboxylic acid having 1 to 10 carbon atoms).

In particular embodiments, the one or more active ingredients contain one or more herbicides selected from dinitroaniline herbicides, synthetic auxins, nitrile herbicides, and derivatives (e.g. esters or salts) thereof. In further embodiments, the one or more active ingredients contain one or more herbicides selected from dinitroaniline type herbicides, pyridine-carboxylic acid synthetic auxins, nitrile herbicides, and derivatives (e.g. esters or salts) thereof Examples of dinitroaniline herbicides include trifluralin, benfluralin, butralin, ethalfluralin, dinitramine, oryzalin, and pendimethalin.

Examples of synthetic auxins include pyridine-carboxylic acids (such as fluroxypyr, aminopyralid, clopyralid, picloram, and triclopyr), benzoic acids (such as chloramben, dicamba, and 2,3,6-trichlorobenzoic acid or TBA), phenoxy-carboxylic acids (such as 2-methyl-4-chlorophenoxyacetic acid or MCPA; 4-(4-chloro-2-methylphenoxy)butyric acid or MCPB; methylchlorophenoxypropionic acid or MCPP; dichlorprop or 2,4-DP; 2,4-Dichlorophenoxyacetic acid or 2,4 D; and 2,4-Dichlorophenoxybutyric acid or 2,4-DP), quinolinecarboxylic acids (such as quinclorac and quinmerac), benazolin-ethyl, or esters thereof.

Examples of nitrile herbicides include bromoxynil, ioxynil, and bromofenoxim.

Examples of nitrile herbicide esters include xynil esters such as bromoxynil octanoate and ioxynil octanoate.

An example of aminopyridine herbicides includes halauxifen-methyl.

Examples of triazolinone herbicides include sulfentrazone, azafenidin, bencarbazone, and carfentrazone-ethyl.

Examples of chloroacetamide herbicides include acetochlor, alachlor, butachlor, dimetachlor, dimethenamid, meazachlor, metolachlor, pethoxamid, pretilachlor, propachlor, propisochlor, and thenylchlor.

Examples of amide herbicides include propanil and pentanochlor.

An example of quinolone herbicides includes cloquintocet-mexyl.

Examples of pyrimidinedione herbicides include saflufenacil, benzfendizone, and butafenacil.

Examples of triazine herbicides include ametryn, atrazine, cyanazine, hexazinone, prometon, prometryn, propazine, simazine, simetryn, terbuthylazine, and terbutryn.

In particular embodiments, the one or more active ingredients contain one or more insecticides. Non-limitative examples of suitable insecticides include carbamates such as carbaryl and methomyl; organophosphorus insecticides such as malathion, methyl parathion, acephate, dimethoate, fonofos, parathion, chlorpyrifos, and diazinon; pyrethroids such as cypermethrin, bifenthrin, permethrin, tefluthrin, bioresmethrin, resmethrin, allethrin, cyfluthrin, and deltamethrin; nicotinoids such as imidaclodrid; pyrazoles such as fipronil; and organochlorines such as endosulfan.

In particular embodiments, the one or more active ingredients contain one or more fungicides. Non-limitative examples of suitable fungicides include antibiotic fungicides such as azoxystrobin and kresoxim-methyl; dithiocarbamates such as maneb and mancozeb; aliphatic nitrogen fungicides; amides; aromatic fungicides; benzimidazoles; benzimidazole precursors; carbamates; dicarboximides; dinitrophenols; thiocarbamates; dithiocarbamates; ureas; pyrimidines; quinolines; quinones; quinoxalines; various unclassified fungicides such as fenpropidin and piperalin; morpholines such as fenpropimorph and tridemorph; conazoles such as flusilazole, propiconazole, tebuconazole, and triadimefon; pyridines such as pyrifenox; thiazoles such as etridiazole; organophosphorous compounds such as phosdiphen; and imidazoles such as pefurazoate.

The compositions described herein can be used as emulsifiable concentrates, therefore they may be blended with water to form an emulsion. The emulsion forms a vehicle for the active ingredient to contact plant surfaces (e.g. from crops or weeds) to deliver the active ingredient efficiently. Whereas the composition may be blended with water, the composition as such (i.e. before blending with water) typically contains less than 5 wt % water, alternatively less than 2 wt % water, or even less than 1 wt % water.

In order to facilitate the formation of an emulsion, the compositions described herein may comprise one or more surfactants. Suitable surfactants include non-ionic, anionic, cationic, amphoteric or zwitterionic surfactants.

Suitable non-ionic surfactants include, but are not limited to, polyethylene glycol surfactants, polyhydric alcohol surfactants, acetylene surfactants, alkyl glycosides, alkyl phenol ethoxylates, alcohol ethoxylates, sorbitan esters, alkyl polyglycosides, organosilicone surfactants, and other non-ionic surfactants customarily used in the agricultural chemical technology that are known to the person skilled in the art.

Suitable anionic surfactants include, but are not limited to, carboxylic acid surfactants and their salts, sulfate surfactants and their salts, sulfonic acid surfactants and their salts, phosphate surfactants and their salts, and other anionic surfactants customarily used in the agricultural chemical technology that are known to the person skilled in the art.

Suitable cationic surfactants include, but are not limited to, alkyl amine salts, alkyl quaternary ammonium salts, and other cationic surfactants customarily used in the agricultural chemical technology that are known to the person skilled in the art.

Other suitable surfactants include, but are not limited to, amphoteric surfactants such as betaine and amino acid surfactants, zwitterionic surfactants, silicone surfactants, and fluorochemical surfactants.

Although the function of an individual surfactant is dependent on the specific pesticide emulsion in which it is used, typical functions of some non-ionic surfactants are as follows. The ethoxylated nonionic surfactants can function as primary emulsifiers. The sorbitan esters (not ethoxylated) can function as both coupling agents and secondary emulsifiers. The alkyl polyglycosides can function as compatibility agents for high electrolyte tank mixes. The organosilicones can be used as superspreading surfactants.

Typical functions of anionic surfactants include, but are not limited to, acting as secondary emulsifiers, as compatibility agents for high electrolyte tank mixes, and as acidifying agents to reduce the pH of the spray mixes.

In addition to the active ingredient(s), solvent(s), and optional surfactant(s), the compositions provided herein may further comprise one or more additives or adjuvants such as a defoamer (e.g. dimethylsiloxane or polydimethylsiloxane), stabilizer (e.g. UV absorbents, free radical scavengers, and anti-oxidants), thickener, corrosion inhibitor, activator, wetting agent, colorant, humectant, preservative (e.g. bactericide), anti-freeze agent, sticker or adhesive (e.g. polyvinyl alcohols, polyvinyl acetates, or polyacrylates), and the like. Some of these additives may already be present in the compositions provided herein, or may be added afterwards upon or after blending with water.

As described above, the compositions provided herein comprise one or more active ingredients, one or more solvents, and optionally one or more surfactants. Suitable relative amounts of the various components may depend on the type of active ingredient and desired application, and can be determined by the skilled person without undue burden.

In particular embodiments, the agrochemical compositions described herein comprise:
to 80 wt % of the one or more active ingredients;
to 95 wt % of one or more solvents;
0 to 20 wt % of the one or more surfactants; and
0 to 20 wt % additives.

In particular embodiments, the composition comprises less than 10 wt % additives, or even less than 5 wt % additives.

In particular embodiments, the active ingredient(s), solvent(s) (including optional co-solvents), and surfactant(s) together may form more than 80 wt %, more than 90 wt %, or more than 95 wt % of the composition.

As described above, the one or more solvents contained in the composition may contain one or more other solvents (co-solvents) than solvent (a), (b), or (c) as described above. While the co-solvents are generally described herein as solvents other than the solvent selected from solvent (a), (b), or (c), it will be understood by the skilled person that in embodiments focused on a specific subset of solvents (a), (b), and (c); any solvent outside that subset would be considered a co-solvent, even if such co-solvent is also selected from solvents (a), (b), or (c). For example, in embodiments focused on solvent (a) (i.e. the one or more solvents are selected from solvent (a)), the co-solvent may include solvent (b) and/or (c) (as well as other co-solvents). As a further example, in embodiments focused on solvent (a) wherein R¹ is branched C₉alkyl, the co-solvent may include solvent (a) wherein R¹ is branched C₁₀alkyl.

In preferred embodiments, the solvents contain at least 50 wt %, at least 75 wt %, at least 95 wt %, or at least 99 wt % of one or more solvents selected from solvent (a), (b), or (c) as described above. More particularly, in certain embodiments, the agrochemical compositions described herein comprise:
to 80 wt % of the one or more active ingredients;
to 95 wt % of one or more solvents selected from solvent (a), (b), or (c) as described above;
0 to 50 wt % of one or more co-solvents;
0 to 20 wt % of the one or more surfactants; and
0 to 20 wt % additives.

In particular embodiments, the agrochemical compositions described herein comprise:
to 70 wt % of the one or more active ingredients;
to 95 wt % of one or more solvents selected from solvents (a), (b), and (c) described above;
0 to 25 wt % of other solvents;
0 to 10 wt % of the one or more surfactants; and
0 to 10 wt % additives.

In such embodiments, the active ingredient(s); solvents selected from solvent (a), (b), or (c); co-solvents; and surfactant(s) preferably constitute at least 90 wt % of the composition.

In embodiments where one or more surfactants are present in the composition described herein, the composition typically comprises 1 wt % to 20 wt % of surfactant(s), alternatively 3 wt % to 15 wt %, or alternatively 4 wt % to 10 wt %. In particular embodiments, the agrochemical compositions described herein comprise:
to 70 wt % of said one or more active ingredients;
to 94 wt % of said one or more solvents selected from solvents (a), (b), and (c) described above;
0 to 10 wt % of other solvents
1 to 10 wt % of said one or more surfactants; and
0 to 5 wt % additives.

In such embodiments, the active ingredient(s); solvents selected from solvent (a), (b), or (c); co-solvents; and surfactant(s) preferably constitute at least 95 wt % of the composition.

The solvents used in the compositions described herein provide a good solubility for a variety of active ingredients useful in agriculture. Accordingly, further provided herein is the use of such solvents as a solvent for an organic agriculturally active ingredient. More specifically, provided herein is the use of a solvent selected from:
(a) an amide of formula R¹—C(O)—N(R²)₂, wherein R¹ is a branched C₉-C₁₅alkyl and R² is C₁-C₄alkyl;
(b) an ester of formula R³—C(O)—OR⁴, wherein R³ is a branched C₄-C₈alkyl, and R⁴ is C₆₋₁₀aryl; and
(c) an ester of formula R⁵—C(O)—OX—R⁶, wherein R⁵ is C₆₋₁₀aryl, X represents a single bond or an C₁-C₄alkylene group, and R⁶ is secondary butyl or cyclohexyl;
as a solvent for an organic agriculturally active ingredient.

The details regarding the solvent and active ingredient set out above with regard to the composition, equally apply to the uses provided herein.

### Emulsion

As described above, the compositions described herein may be diluted and blended with water to form an emulsion. Accordingly, further provided herein is an emulsion comprising the agrochemical composition as described herein, and water. In particular embodiments, the emulsion may be prepared by blending the agrochemical composition with water in an agrochemical composition:water ratio ranging from 1:5 to 1:5000.

Further described herein is a method for protecting a crop, more particularly for protecting a crop from one or more pests, comprising blending an agrochemical composition as described herein with water to form an emulsion; and applying said emulsion to the crop.

Further disclosed are the following embodiments of the methods described herein:

Embodiment 1. An agrochemical composition comprising:
one or more active ingredients;
one or more solvents selected from the list consisting of:
   (a) an amide of formula R¹—C(O)—NR²R³, wherein R¹ is a branched C₉-C₁₅alkyl and R² and R³ are independently C₁-C₄alkyl;
   (b) an ester of formula R⁴—C(O)—OR⁵, wherein R⁴ is a branched C₄-C₈alkyl or isopropyl, and R⁵ is a methyl or ethyl group substituted with an aromatic substituent selected from phenyl or naphthalenyl, wherein the aromatic substituent itself is optionally substituted with up to two
   C₁₋₂alkyl groups;
   and
   (c) an ester of formula R⁶—C(O)—OX—R⁷, wherein R⁶ is phenyl, benzyl, or naphthalenyl, optionally substituted with up to two methyl groups, X represents a single bond or a C₁-C₄alkylene group, and R⁷ is secondary butyl, cyclohexyl, or isooctyl, wherein the cyclohexyl is optionally substituted with up to two methyl groups; preferably R⁷ is secondary butyl or cyclohexyl, wherein the cyclohexyl is optionally substituted with up to two methyl groups;
      and
optionally, one or more surfactants.

Embodiment 2. The agrochemical composition of embodiment 1, wherein said one or more solvents comprise an amide of formula R¹—C(O)—NR²R³, wherein R¹ is a branched C₉alkyl and R² and R³ are methyl or ethyl.

Embodiment 3. The agrochemical composition of embodiment 2, wherein R² and R³ are methyl.

Embodiment 4. The agrochemical composition of embodiment 1, wherein said one or more solvents comprise an ester of formula R⁴—C(O)—OR⁵, wherein R⁴ is C₄-C₈alkyl containing at least two tertiary carbon atoms or at least one quaternary carbon atom, and R⁵ is as defined in embodiment 1.

Embodiment 4. The agrochemical composition of embodiment 4, wherein R⁵ is benzyl.

Embodiment 5. The agrochemical composition of embodiment 4 or 5, wherein R⁴ is tert-butyl.

Embodiment 6. The agrochemical composition of embodiment 1, wherein said solvent comprises secondary butyl benzoate, cyclohexyl benzoate, or a mixture thereof.

Embodiment 7. The agrochemical composition of any one of embodiments 1 to 6, comprising 5 to 80 wt % of said one or more active ingredients; 5 to 95 wt % of said one or more solvents; 0 to 50 wt % of one or more co-solvents; and 0 to 20 wt % of said one or more surfactants; preferably wherein the active ingredients, solvents, and co-solvents form at least 80 wt % of the composition; and the ratio solvent:co-solvent is more than 1.

Embodiment 8. The agrochemical composition of embodiment 7, comprising 10 to 65 wt % of said one or more active ingredients; 20 to 90 wt % of said one or more solvents; optionally up to 25 wt % of one or more co-solvents; and 0 to 15 wt % of said one or more surfactants; preferably wherein the active ingredients, solvents, and co-solvents form at least 90 wt % of the composition; and the ratio solvent:co-solvent is more than 1.

Embodiment 9. The agrochemical composition of any one of embodiments 1 to 8, wherein said one or more active ingredients are pesticides selected from the list consisting of herbicides, insecticides, fungicides, acaricides, nematicides, miticides, rodenticides, bactericides, molluscicides, bird repellents, and combinations thereof.

Embodiment 10. The agrochemical composition of any one of embodiments 1 to 9, wherein said one or more active ingredients include one or more herbicides selected from a dinitroaniline type herbicide, a synthetic auxin, a nitrile herbicide, and derivatives thereof.

Embodiment 11. The agrochemical composition of any one of embodiments 1 to 9, wherein said one or more active ingredients include one or more herbicides selected from dinitroaniline type herbicides, pyridine-carboxylic acid synthetic auxins, nitrile herbicides, and derivatives (e.g. esters or salts) thereof.

Embodiment 12. The agrochemical composition of any one of embodiments 1 to 11, wherein said one or more solvents comprises said amide of formula R¹—C(O)—NR²R³; and said active ingredient comprises a synthetic auxin

Embodiment 13. The agrochemical composition of embodiment 12, wherein said synthetic auxin is a phenoxy-carboxylic acid type auxin.

Embodiment 14. The agrochemical composition according to any one of embodiments ito 13, comprising at least 1.0 wt % of one or more surfactants selected from a cationic surfactant, an anionic surfactant, and a non-ionic surfactant.

Embodiment 15. An emulsion comprising the agrochemical composition of any one of embodiments 1 to 14, and water.

Embodiment 16. The emulsion of embodiment 15, comprising 0.02 to 20 wt % of said agrochemical composition, and 80 to 99.98 wt % water.

Embodiment 16. The emulsion of embodiment 15, comprising 0.1 to 10 wt % of said agrochemical composition, and 90 to 99.9 wt % water.

Embodiment 17. The use of a solvent selected from (a) an amide of formula R¹—C(O)—N(R²)₂, wherein R¹ is a branched C₉-C₁₅alkyl and R² is C₁-C₄alkyl; (b) an ester of formula R³—C(O)—OR⁴, wherein R³ is a branched C₄-C₈alkyl, and R⁴ is C₆₋₁₀aryl; and (c) an ester of formula R⁵—C(O)—OX—R⁶, wherein R⁵ is C₆₋₁₀aryl, X represents a single bond or an C₁-C₄alkylene group, and R⁶ is secondary butyl or cyclohexyl; as a solvent for an organic agrochemical.

Embodiment 18. The use of embodiment 17, wherein said solvent is or comprises an amide of formula R¹—C(O)—NR²R³, wherein R¹ is a branched C₉alkyl and R² and R³ are methyl or ethyl.

Embodiment 19. The use of embodiment 18, wherein R² and R³ are methyl.

Embodiment 20. The use of embodiment 17, wherein said solvent is or comprises an ester of formula R⁴—C(O)—OR⁵, wherein R⁴ is C₄-C₈alkyl containing at least two tertiary carbon atoms or at least one quaternary carbon atom, and R⁵ is as defined in embodiment 17.

Embodiment 21. The use of embodiment 20, wherein R⁵ is benzyl.

Embodiment 22. The use of embodiment 20 or 21, wherein R⁴ is tert-butyl.

Embodiment 23. The use of embodiment 17, wherein said solvent is or comprises secondary butyl benzoate, cyclohexyl benzoate, or a mixture thereof.

Embodiment 24. The use of any one of embodiments 17 to 23, wherein said organic agrochemical is a pesticide selected from the list consisting of herbicides, insecticides, fungicides, acaricides, nematicides, miticides, rodenticides, bactericides, molluscicides, bird repellents, and combinations thereof.

Embodiment 25. The use of any one of embodiments 17 to 23, wherein said organic agrochemical is or includes one or more herbicides selected from a dinitroaniline type herbicide, a synthetic auxin, a nitrile herbicide, and derivatives thereof.

Embodiment 26. The use of any one of embodiments 17 to 23, wherein said organic agrochemical is or includes one or more herbicides selected from dinitroaniline type herbicides, pyridine-carboxylic acid synthetic auxins, nitrile herbicides, and derivatives (e.g. esters or salts) thereof Embodiment 27. The use of any one of embodiments 17 to 19, wherein said solvent is or comprises an amide of formula R¹—C(O)—NR²R³; and said organic agrochemical is or comprises a synthetic auxin, preferably a phenoxy-carboxylic acid type auxin.

Embodiment 28. A method for protecting a crop, comprising blending an agrochemical composition according to any one of embodiments 1 to 14 with water to form an emulsion; and applying said emulsion to the crop.

### EXAMPLES

### Synthesis of Esters and Amide

A general procedure was followed to prepare the esters and amide of the examples. Carboxylic acids were converted to the corresponding acid chloride at 80° C. with an excess amount of thionyl chloride. Subsequently the acid chloride was reacted with excess amount of an alcohol or an amine in hexane at 0° C. under atmosphere pressure, thereby obtaining the corresponding ester (reaction of acid chloride with alcohol) or amide (reaction of acid chloride with amine). Water was added to the reaction mixture to dissolve the solid by-product (HCl) which also led to phase separation with hexane (containing the ester or amide). The ester or amide was recovered by extraction and vacuum drying.

A list of the solvents and the acid and alcohol or amide used for the preparation thereof, is provided in Table 1. Solvent C₁ is prepared as a comparative example.

TABLE 1
List of esters and amides prepared

| Solvent | Compound | Carboxylic acid | Alcohol or Amide |
|---|---|---|---|
| E1 | Secondary butyl | Benzoic acid | Secondary butyl |
| | benzoate | | alcohol |
| E2 | Cyclohexyl benzoate | Benzoic acid | Cyclohexanol |
| E3 | Isooctyl benzoate | Benzoic acid | Exxal ™ 8 alcohol |
| | | | (isooctanol) (available |
| | | | from ExxonMobil) |
| E4 | Benzyl pivalate | Pivalic acid | Benzyl alcohol |
| E5 | N,N-dimethyl | Neodecanoic | Dimethylamine |
| | neodecanamide | acid | |
| C1 | Di-sec butyl furan- | Furan-2,5- | Isobutanol |
| | 2,5-dicarboxylate | dicarboxylic | |
| | | acid | |

In addition, the commercially available solvents listed in Table 2 were used as comparative examples C₂-C₈. Whereas most of these solvents are known to be used in pesticide formulations, solvent C₆ is sold as a plasticizer.

TABLE 2
Commercially available solvents

| Solvent | Description |
|---|---|
| C2 | Aromatic 200, available from ExxonMobil |
| C3 | Butyl benzoate |
| C4 | Benzyl acetate |
| C5 | linear N,N-dimethyldecanamide |
| C6 | Jayflex ™ MB10 plasticizer (isodecyl benzoate), available |
| | from ExxonMobil |
| C7 | Exxate ™ 800 (isooctyl acetate), available from Hallstar |
| C8 | Exxate ™ 900 (isononyl acetate), available from Hallstar |

### Physical Property Characterization of Synthesized Esters and Amide

The following properties of the solvents were tested:
Kinematic viscosity at 25° C. (KV25) was determined based on the method described in ASTM D7042.
Density at 25° C. was determined based on the method described in ASTM D4052.
Pour point was determined according to ASTM D5950.
Water content of the solvents was determined via Karl Fischer titration according to ASTM E1064.
Water solubility in solvent and solvent solubility in water were determined as follows: 20 grams of tested solvent is mixed with 20 grams of water, the mixture was stirred for 2 hours and then transferred to a separating funnel. The funnel containing the mixture was inverted several times. The water and solvent phases were allowed to separate for 24 hours, resulting in two distinct phases. For water solubility in solvent, the solvent layer was transferred to a sample vial and was tested for water content according to ASTM E1064. For solvent solubility in water, the water layer was transferred to a sample vial and was tested by a gas chromatography test method for solvent content. Water content, water solubility, and solvent solubility in water were not tested for solvents C₂-C₅.

The results are provided in Table 3.

TABLE 3
Physical properties of solvents

| | | Density | | | Water | Solvent |
|---|---|---|---|---|---|---|
| | | at | Pour | Water | solubility | solubility |
| | KV25 | 25° C. | Point | content | in solvent | in water |
| Solvent | (cSt) | (g/mL) | (° C.) | (ppm w/w) | (vol %) | (wt %) |
| E1 | 3.38 | 0.992 | −81 | 499 | 0.386 | 0.008 |
| E2 | 11.96 | 1.042 | −54 | 102 | 0.394 | 0.007 |
| E3 | 6.53 | 0.962 | — | 113 | 0.265 | <0.001 |
| E4 | 3.40 | 0.966 | −90 | 232 | 0.422 | 0.010 |
| E5 | 7.29 | 0.883 | −72 | 589 | 2.457 | 0.141 |
| C1 | 66.27 | 1.047 | — | 269 | 0.699 | 0.003 |
| C2 | 3.17 | 0.983 | −30 | — | — | — |
| C3 | 3.11 | 1.001 | −36 | — | — | — |
| C4 | 2.20 | 1.051 | −90 | — | — | — |
| C5 | 5.33 | 0.876 | −6 | — | — | — |
| C6 | 9.60 | 0.949 | −69 | 332 | 0.173 | <0.001 |
| C7 | 1.69 | 0.868 | −105 | 699 | 0.448 | 0.005 |
| C8 | 2.15 | 0.867 | −102 | 722 | 0.369 | <0.001 |

From Table 3, it can be seen that all solvents have a Kinematic viscosity at 25° C. below 12 cSt, except solvent C₁. In general, high viscosities are less preferred in emulsifiable concentrates, since this can lower the maximal loading of active ingredients. Besides solvent C1, all solvents are considered having a suitable viscosity.

The solvents also have densities at 25° C. which are relatively close to water. Densities close to that of water are preferred, as this improves the emulsion stability when the solvent and active ingredient are mixed with water. Indeed, if the solvent density is too low or too high compared to that of water, an emulsion of the solvent in water can have a higher tendency to separate.

Insofar measured, solvents E1-E5 have a very low pour point (below −50° C.), comparing favorably to solvents C2, C3, and C5. Only solvents C4, and C6-C8 have an equal or even lower pour point. A low pour point of the solvent allows for pesticide application under cold conditions.

The esters generally have a very low inherent water content and exhibit low water solubility in solvent and low solvent solubility in water. This is beneficial for emulsifiable concentrate formulations. Indeed, a low solubility in water and low water solubility in solvent ensures that sufficient solvent remains available to dissolve active ingredients when preparing aqueous emulsions of the emulsifiable concentrate, thereby preventing the active ingredients from precipitating. While amide solvent E5 has a higher water content and solubility, the values are still sufficiently low for use in emulsifiable concentrates.

### Solvency Tests

Solvency of solvents E1-E5 and C₁-C₈ was tested by dissolving various solid active ingredients in each solvent. The following pesticides were tested as active ingredients: trifluralin, fluroxypyr, bromoxynil octanoate, and 2-methyl-4-chlorophenoxyacetic acid (MCPA). Solvency was characterized by the weight ratio of an active ingredient in a solvent and was determined by adding 0.5 gram of active ingredient to a vial equipped with a stir bar and then charging the solvent to achieve a desired concentration. The vials were capped and placed into a water bath kept at a temperature 5 to 10° C. below the melting point of tested pesticide. The mixture was stirred in the vial for 24 hours. If the active ingredient was fully dissolved, the mixture was transferred to a room temperature water bath. If no active ingredient crystals were formed, a higher concentration of active ingredient was tested. Conversely, if active ingredient crystals were formed, a lower concentration of active ingredient was tested. Solubility was recorded as the highest concentration of active ingredient in the tested solvent with no formation of crystals. Concentrations were tested at a 5% interval. For example, if the active ingredient was dissolved at 50%, 55% would be the next concentration to be tested. Concentrations below 15 wt % were not tested. The test results are provided in Table 4.

Hydrolytic stability was characterized by mixing the tested solvent with an excess of pH 4.5 or pH 8.5 buffer in a vial which was placed in a heated water bath (54° C.). After 14 days, the vial was cooled to room temperature and the content was allowed to separate into aqueous and organic (solvent) phases. The solvent phase was transferred to a clean vial and sodium sulfate was added to remove residual water. The mixture was filtered to obtain the solvent filtrate which was analyzed by ¹³C NMR to measure the amount of hydrolysis products (acid or alcohol), if any.

Hydrolytic stability for solvents E3, C₁, C₂, and C₆-C₈ was not tested. No hydrolysis is expected for aromatic solvent C₂ due to lack of hydrolysable bonds.

TABLE 4
Solvency test results (results in wt % active ingredient in solution)

| | | | Bromo- | | Hydrolysis | Hydrolysis |
|---|---|---|---|---|---|---|
| | Triflu- | Flur- | xynil | | at pH 4.5 | at pH 8.5 |
| Solvent | ralin | oxypyr | Octanoate | MCPA | (%) | (%) |
| E1 | 72.6 | 61.3 | 73.0 | <15 | <1.0 | 3.7 |
| E2 | 66.8 | 64.8 | 68.3 | <15 | 2.7 | 1.7 |
| E3 | 64.1 | 50.8 | 68.6 | <15 | — | — |
| E4 | 69.5 | 66.0 | 68.8 | <15 | 0.3 | <1.0 |
| E5 | 65.0 | 63.0 | 63.5 | 29.7 | <1.0 | <1.0 |
| C1 | 37.1 | <15 | 48.3 | <15 | — | — |
| C2 | 66.8 | 59.9 | 70.5 | <15 | n/a | n/a |
| C3 | 62.8 | 48.9 | 69.7 | <15 | 0.5 | 6.7 |
| C4 | 61.2 | 59.8 | 72.9 | 15.1 | 22.5 | 6.8 |
| C5 | 62.4 | 62.2 | 60.2 | <15 | <1.0 | <1.0 |
| C6 | 54.5 | 27.4 | 62.1 | <15 | — | — |
| C7 | 77.3 | 60.2 | 70.9 | <15 | 12.6 | <1.0 |
| C8 | 72.9 | <15 | 67.5 | <15 | — | — |

From Table 4, it can be seen that solvents E1-E5 provide an excellent solvency (>50 wt %) for trifluralin, fluroxypyr, and bromoxynil octanoate, similar to the solvency provided by aromatic solvent C₂. Accordingly, solvents E1-E5 provide a good alternative for such aromatic solvents. Moreover, benzoate esters E1-E3 compare well with benzoate esters C₃ and C₆, which have a solvency below 50 wt % for fluroxypyr. Benzyl pivalate E4 provides a similar solvency compared to benzyl acetate C₄, while providing a significantly better hydrolytic stability. In addition, amide E5 exhibited higher solvency compared with amide C5 against trifluralin, fluroxypyr and bromoxynil octanoate.

Most solvents, including the comparative solvents, were found to provide a lower solvency for MCPA compared to the other three pesticides. Surprisingly, amide E5 was found to provide a solvency for MCPA of about 30 wt %, which is significantly better than comparative amide C5. From Table 2, it is also clear that solvent E5 has a much lower pour point compared to C5.

Any alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

1. An agrochemical composition comprising:
one or more active ingredients;
one or more solvents selected from the list consisting of:
(a) an amide of formula R¹—C(O)—NR²R³, wherein R¹ is a branched C₉-C₁₅alkyl and R² and R³ are independently C₁-C₄alkyl;
(b) an ester of formula R⁴—C(O)—OR⁵, wherein R⁴ is a branched C₄-C₈alkyl or isopropyl, and R⁵ is a methyl or ethyl group substituted with an aromatic substituent selected from phenyl or naphthalenyl, wherein the aromatic substituent itself is optionally substituted with up to two C₁₋₂alkyl groups; and
(c) an ester of formula R⁶—C(O)—OX—R⁷, wherein R⁶ is phenyl, benzyl, or naphthalenyl, optionally substituted with up to two methyl groups, X represents a single bond or a C₁-C₄alkylene group, and R⁷ is secondary butyl or cyclohexyl, wherein the cyclohexyl is optionally substituted with up to two methyl groups;
and
optionally, one or more surfactants.

2. The agrochemical composition of claim 1, wherein said one or more solvents comprise an amide of formula R¹—C(O)—NR²R³, wherein R¹ is a branched C₉alkyl and R² and R³ are methyl or ethyl.

3. The agrochemical composition of claim 1, wherein said one or more solvents comprise an ester of formula R⁴—C(O)—OR⁵, wherein R⁴ is C₄-C₈alkyl containing at least two tertiary carbon atoms or at least one quaternary carbon atom, and R⁵ is as defined in claim 1.

4. The agrochemical composition of claim 3, wherein R⁵ is benzyl.

5. The agrochemical composition of claim 3, wherein R⁴ is tert-butyl.

6. The agrochemical composition of claim 1, wherein said solvent comprises secondary butyl benzoate, cyclohexyl benzoate, or a mixture thereof.

7. The agrochemical composition of any one of claim 1, comprising:
5 to 80 wt % of said one or more active ingredients;
5 to 95 wt % of said one or more solvents; and
0 to 20 wt % of said one or more surfactants.

8. The agrochemical composition of claim 1, wherein said one or more active ingredients are pesticides selected from the list consisting of herbicides, insecticides, fungicides, acaricides, nematicides, miticides, rodenticides, bactericides, molluscicides, bird repellents, and combinations thereof.

9. The agrochemical composition of claim 1, wherein said one or more active ingredients include one or more herbicides selected from a dinitroaniline type herbicide, a synthetic auxin, a nitrile herbicide, and derivatives thereof.

10. The agrochemical composition of claim 1, wherein
said one or more solvents comprises said amide of formula R¹—C(O)—NR²R³; and
said active ingredient comprises a synthetic auxin.

11. The agrochemical composition according to claim 1, comprising at least 1.0 wt % of one or more surfactants selected from a cationic surfactant, an anionic surfactant, and a non-ionic surfactant.

12. An emulsion comprising the agrochemical composition of claim 1, and water.

13. (canceled)

14. A method for protecting a crop, comprising blending an agrochemical composition according to claim 1 with water to form an emulsion; and applying said emulsion to the crop.
